(19) United States
(12) Patent Application Publication
(10) Pub. No.: US 2025/0300349 A1
(43) Pub. Date: Sep. 25, 2025

(54) LOWER BAND RADIATING ELEMENTS HAVING REDUCED SCATTERING OF HIGHER-BAND RADIATION

(71) Applicant: Outdoor Wireless Networks LLC, Richardson, TX (US)

(72) Inventors: Jian Zhang, Suzhou (CN); Changfu Chen, Suzhou (CN); Bo Wu, Allen, TX (US); Bin Sun, Suzhou (CN); Cheng Xue, Suzhou (CN); Pengfei Guo, Suzhou (CN)

(21) Appl. No.: 19/057,235

(22) Filed: Feb. 19, 2025

(30) Foreign Application Priority Data
Mar. 25, 2024 (CN) 202410345643.3

(51) Int. Cl. H01Q 5/48; H01Q 1/52; H01Q 21/06

(52) U.S. Cl. CPC H01Q 5/48; H01Q 1/52; H01Q 21/062

(57) ABSTRACT

A radiating element includes a feed stalk printed circuit board that comprises first and second RF transmission lines, a first dipole radiator that is coupled to the first RF transmission line and a second dipole radiator that is coupled to the second RF transmission line. The first dipole radiator comprises first and second dipole arms, and the second dipole radiator comprises third and fourth dipole arms. A first amount of coupling between the first dipole arm and the third dipole arm exceeds a second amount of coupling between the first dipole arm and the fourth dipole arm.

### CROSS-REFERENCE TO RELATED APPLICATIONS

The present application claims priority to Chinese Patent Application No. 2024103456433, filed Mar. 25, 2024, the entire content of each of which is incorporated herein by reference.

### BACKGROUND

The present invention generally relates to radio communications and, more particularly, to base station antennas for cellular communications systems and to radiating elements for such base station antennas.

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with fixed and mobile subscribers that are within the cell served by the base station. Typically, the base station antennas are mounted on a tower or other raised structure, with the radiation patterns (also referred to herein as “antenna beams”) that are generated by the base station antennas directed outwardly.

A common base station configuration is the three sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays,” and may be straight columns of radiating elements or columns in which some of the radiating elements are staggered horizontally. Most modern base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-polarized radiating elements, which allows each linear array to simultaneously transmit and/or receive RF signals at two orthogonal polarizations.

Each of the above-described linear arrays is coupled to two ports of a radio (one port for each polarization). An RF signal that is to be transmitted by a linear array is passed from the radio port to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a sector of a cell. The relative phases of the sub-components of the RF signal are set (e.g., using phase delay lines) so that the individual radiation patterns generated by each subset of radiating elements constructively combine to narrow the half power beamwidth (“HPBW”) of the generated antenna beams in the elevation (vertical) plane. Since the above-described 2G/3G/4G linear arrays generate static antenna beams, they are often referred to as “passive” linear arrays.

Most cellular operators are currently upgrading their networks to support fifth generation (“5G”) cellular service. One important component of 5G cellular service is the use of so-called “active” beamforming arrays that operate in conjunction with active beamforming radios to dynamically adjust the size, shape and pointing direction of the antenna beams that are generated by the active beamforming array. These active beamforming arrays include multiple columns of radiating elements, with eight columns being the most common, Active beamforming arrays are typically formed using “high-band” radiating elements that operate in higher frequency bands, such as some or all of the 3.1-4.2 GHz and/or the 5.1-5.8 GHz frequency bands, although active beamforming arrays may also be provided that operate in other frequency bands such as the upper portion of the mid-band frequency range (e.g., 2300-2690 MHz). Each column of radiating elements of such an active beamforming array is typically coupled to a respective port of a beamforming radio. The beamforming radio may be a separate device, or may be integrated with the active antenna array. The beamforming radio may dynamically adjust the amplitudes and phases of the sub-components of an RF signal that are fed to each column of the beamforming array to generate antenna beams that have narrowed beamwidths in the azimuth plane (and hence higher antenna gain). These narrowed antenna beams can be electronically steered in the azimuth plane by proper selection of the amplitudes and phases of the sub-components of an RF signal.

In order to avoid having to increase the number of antennas at cell sites, the above-described 5G antennas often include passive linear arrays that support legacy 2G, 3G and/or 4G cellular services. In one popular solution, a 5G active antenna module (i.e., a module that includes an active beamforming array and associated beamforming radio) is mounted behind a passive base station antenna that includes a plurality of 2G, 3G, and/or 4G passive linear arrays. An opening is provided in the reflector of the passive base station antenna so that the antenna beams generated by the active beamforming array can be transmitted through the passive base station antenna. Typically, some of the radiating elements of the 2G/3G/4G passive linear arrays are mounted in front of the radiating elements of the beamforming array. The above-described antenna design is advantageous as the active antenna module may be removable, and hence as enhanced 5G capabilities are developed, a cellular operator may replace the original active antenna module with an upgraded active antenna module without having to replace the passive base station antenna. Herein, the combination of a passive base station antenna that has an active antenna module mounted thereon is referred to as a “passive/active antenna system.”

### SUMMARY

Pursuant to embodiments of the present invention, radiating elements are provided that include a feed stalk printed circuit board that comprises first and second RF transmission lines, a first dipole radiator that is coupled to the first RF transmission line, and a second dipole radiator that is coupled to the second RF transmission line. The first dipole radiator comprises first and second dipole arms, and the second dipole radiator comprises third and fourth dipole arms. A first amount of coupling between the first dipole arm and the third dipole arm exceeds a second amount of coupling between the first dipole arm and the fourth dipole arm.

In some embodiments, a third amount of coupling between the second dipole arm and the fourth dipole arm exceeds a fourth amount of coupling between the second dipole arm and the third dipole arm.

In some embodiments, the feed stalk printed circuit board is positioned between the first dipole arm and the third dipole arm and between the second dipole arm and the fourth dipole arm.

In some embodiments, each of the first through fourth dipole arms is positioned next to two other of the first through fourth dipole arms so that the first through fourth dipole arms together define a square when viewed from the front, with each of the first through fourth dipole arms having a first inner side and a second inner side that each extend outwardly from a center of the square and a first outer side and a second outer side that each define a respective portion of a periphery of the square.

In some embodiments, each of the first through fourth dipole arms comprises a metal loop having an open interior.

In some embodiments, a difference between the first amount of coupling and the second amount of coupling is provided by a first capacitor that is provided between a distal end of the first inner side of the first dipole arm and a distal end of the second inner side of the third dipole arm. In some embodiments, a difference between the third amount of coupling and the fourth amount of coupling is provided by a second capacitor provided between a distal end of the first inner side of the second dipole arm and a distal end of the second inner side of the fourth dipole arm. In some embodiments, the first and second capacitors are configured to improve isolation between the first and second dipole radiators.

In some embodiments, he radiating element is provided in combination with a base station antenna, where the radiating element is one of a plurality of lower frequency band radiating elements. The base station antenna further comprises an array of higher frequency band radiating elements that is mounted rearwardly of the radiating element. In some embodiments, the radiating element further comprises first through fourth metal cloaking structures that overlap the respective first through fourth dipole arms, where the first through fourth metal cloaking structures are configured to render the respective first through fourth dipole arms substantially transparent to RF radiation emitted by the higher frequency band radiating elements. In some embodiments, the first through fourth dipole arms and the first through fourth metal cloaking structures are formed on a dielectric substrate of a dipole radiator printed circuit board. In some embodiments, the array of higher frequency band radiating elements comprises a multi-column array of higher frequency band radiating elements with the columns extending in a longitudinal direction of the base station antenna, and wherein first and second major surfaces of the feed stalk printed circuit board extend forwardly from a reflector of the base station antenna and perpendicular to the longitudinal direction. In some embodiments, the first through fourth dipole arms are mounted adjacent a forward end of the feed stalk, and the first through fourth metal cloaking structures are mounted rearwardly of the respective first through fourth dipole arms.

In some embodiments, the metal loop of the first dipole arm may include a slot where the metal is omitted. In such embodiments, the slot may include first and second slot segments that meet to define a right angle. The slot may be positioned adjacent an outer corner of the first dipole arm. In some embodiments, a length of the slot may be a quarter wavelength of a frequency within an operating frequency band of a higher frequency band radiating element that is also included in the base station antenna.

In some embodiments, the radiating element may further comprise first through fourth metal traces that are positioned radially outwardly of the respective first through fourth dipole arms and configured to capacitively couple with the respective first through fourth dipole arms. Each of the first through fourth metal traces may, for example, have a right angle shape. A length of each of the first through fourth metal traces may be a quarter wavelength of a frequency within an operating frequency band of the higher frequency band radiating element.

Pursuant to further embodiments of the present invention, radiating elements are provided that comprise a feed stalk printed circuit board that comprises first and second RF transmission lines, a first dipole radiator that is coupled to the first RF transmission line, and a second dipole radiator that is coupled to the second RF transmission line. The first dipole radiator comprises first and second dipoles arm and the second dipole radiator comprises third and fourth dipole arms. The feed stalk printed circuit board is positioned between the first dipole arm and the third dipole arm and between the second dipole arm and the fourth dipole arm, and distal ends of facing inner sides of the first and third dipole arms are spaced more closely together than distal ends of facing inner sides of the first and fourth dipole arms.

In some embodiments, distal ends of facing inner sides of the second and fourth dipole arms are spaced more closely together than distal ends of facing inner sides of the second and third dipole arms.

In some embodiments, facing inner sides of the first and third dipole arms are symmetric about a first axis and facing inner sides of the first and fourth dipole arms are symmetric about a second axis. In some embodiments, facing inner sides of the second and fourth dipole arms are symmetric about the first axis and facing inner sides of the second and third dipole arms are symmetric about the second axis. In some embodiments, the feed stalk printed circuit board extends along the first axis.

In some embodiments, each of the first through fourth dipole arms is positioned next to two other of the first through fourth dipole arms so that the first through fourth dipole arms together define a square when viewed from the front.

In some embodiments, each of the first through fourth dipole arms comprises a metal loop having an open interior.

In some embodiments, the first RF transmission line is coupled to the first dipole radiator and the second RF transmission line is coupled to the second dipole radiator.

In some embodiments, the radiating element is provided in combination with a base station antenna, where the radiating element is one of a plurality of lower frequency band radiating elements. The base station antenna may include an array of higher frequency band radiating elements that is mounted rearwardly of the radiating element. The radiating element of may further comprise first through fourth metal cloaking structures that overlap the respective first through fourth dipole arms, where the first through fourth metal cloaking structures are configured to render the respective first through fourth dipole arms substantially transparent to RF radiation emitted by the higher frequency band radiating elements. In some embodiments, the array of higher frequency band radiating elements comprises a multi-column array of higher frequency band radiating elements with the columns extending in a longitudinal direction of the base station antenna, and first and second major surfaces of the feed stalk printed circuit board extend forwardly from a reflector of the base station antenna and perpendicular to the longitudinal direction.

In some embodiments, the first through fourth dipole arms and the first through fourth metal cloaking structures are formed on a dielectric substrate of a dipole radiator printed circuit board.

In some embodiments, the first through fourth dipole arms are mounted adjacent a forward end of the feed stalk, and the first through fourth metal cloaking structures are mounted rearwardly of the respective first through fourth dipole arms.

Pursuant to still further embodiments of the present invention, radiating elements are provided that comprise a first dipole radiator that comprises first and second dipoles arm and a second dipole radiator that comprises third and fourth dipole arms.

The first dipole radiator is configured to transmit and receive electromagnetic radiation within a first operating frequency band and the second dipole radiator is configured to transmit and receive electromagnetic radiation within the first operating frequency band. The radiating element further comprises first through fourth metal cloaking structures that form resonant circuits with the respective first through fourth dipole arms. The resonant circuits are configured to allow currents in the first operating frequency band to flow on the first through fourth dipole arms while blocking currents in a second operating frequency band from flowing on the first through fourth dipole arms. A first amount of coupling between the first dipole arm and the third dipole arm exceeds a second amount of coupling between the first dipole arm and the fourth dipole arm.

In some embodiments, a third amount of coupling between the second dipole arm and the fourth dipole arm exceeds a fourth amount of coupling between the second dipole arm and the third dipole arm.

In some embodiments, each of the first through fourth metal cloaking structures forms a multi-stage resonant circuit with a respective one of the first through fourth dipole arms. In some embodiments, each multi-stage resonant circuit comprises a plurality of resonant circuits in series with each other.

In some embodiments, each of the first through fourth dipole arms comprises an annular dipole arm.

In some embodiments, the radiating element further comprises a feed stalk printed circuit board that comprises first and second RF transmission lines that are coupled to the respective first and second dipole radiators. In some embodiments, the feed stalk printed circuit board is positioned between the first dipole arm and the third dipole arm and between the second dipole arm and the fourth dipole arm.

In some embodiments, each of the first through fourth dipole arms is positioned next to two other of the first through fourth dipole arms so that the first through fourth dipole arms together define a square when viewed from the front, and wherein each of the first through fourth dipole arms comprises a metal loop having an open interior.

In some embodiments, a difference between the first amount of coupling and the second amount of coupling is provided by a first capacitor that is provided between a distal end of the first inner side of the first dipole arm and a distal end of the second inner side of the third dipole arm. In some embodiments, a difference between the third amount of coupling and the fourth amount of coupling is provided by a second capacitor provided between a distal end of the first inner side of the second dipole arm and a distal end of the second inner side of the fourth dipole arm. In some embodiments, the first and second capacitors are configured to improve isolation between the first and second dipole radiators.

Pursuant to yet additional embodiments of the present invention, radiating elements are provided that comprise a first dipole radiator that comprises a first dipole arm and a second dipole arm and a second dipole radiator that comprises a third dipole arm and a fourth dipole arm. Each of the first through fourth dipole arms comprises first and second metal dipole arm segments that have a plurality of slots where the metal is omitted, the slots configured to increase a length of a respective current path along each of the first and second metal dipole arm segments.

In some embodiments, the first and second metal dipole arm segments of each of the first through fourth dipole arms together form respective first through fourth metal loops that have open interiors.

In some embodiments, for each of the first through fourth dipole arms, some of the slots are outwardly-extending slots that extend outwardly from inside a respective one of the first through fourth metal loops, while other of the slots are inwardly-extending slots that extend inwardly from outside the respective one of the first through fourth metal loops.

In some embodiments, for each of the first through fourth dipole arms, at least two (or three) of the outwardly-extending slots and at least two (or three) of inwardly-extending slots are arranged in alternating fashion.

In some embodiments, each of the first through fourth metal loops generally defines a respective annular square, and wherein a majority of the slots in each side of each of the annular squares extend perpendicular to a longitudinal direction of the side of the respective annular square.

In some embodiments, the radiating element further comprises a feed stalk having a base and a distal end, where the first and second dipole radiators are mounted adjacent a distal end of the feed stalk.

In some embodiments, the slots have equal widths.

In some embodiments, outer sides of each annular square have substantially constant widths.

In some embodiments, the radiating element further comprises first through fourth metal cloaking structures that overlap the respective first through fourth dipole arms.

Pursuant to further embodiments of the present invention, radiating elements are provided that comprise a first dipole radiator that comprises a first dipole arm and a second dipole arm and a second dipole radiator that comprises a third dipole arm and a fourth dipole arm. Each of the first through fourth dipole arms comprises a metal loop having an open interior, where a respective slot is provided where the metal is omitted in the metal loop of each of the first through fourth dipole arms.

In some embodiments, each slot may include first and second slot segments that meet to define a respective right angle. In some embodiments, each slot is positioned adjacent an outer corner of each of the respective first through fourth dipole arms. In some embodiments, the radiating element may further comprise first through fourth metal traces that are positioned radially outwardly of the respective first through fourth dipole arms and configured to capacitively couple with the respective first through fourth dipole arms. In such embodiments, wherein each of the first through fourth metal traces may have a right angle shape.

### BRIEF DESCRIPTION OF THE DRAWINGS

FIG. 1A is a schematic perspective view of a passive/active antenna system that includes a passive base station antenna that may be implemented using mid-band radiating elements according to embodiments of the present invention.

FIG. 1B is a schematic front view of the passive/active antenna system of FIG. 1A with a frequency selective surface and the radomes thereof omitted.

FIG. 2A is a schematic perspective view of a mid-band cross-dipole radiating element according to embodiments of the present invention.

FIG. 2B is a schematic top view of a feed stalk printed circuit board of the mid-band cross-dipole radiating element of FIG. 2A.

FIG. 2C is a schematic bottom view of the feed stalk printed circuit board of FIG. 2B.

FIG. 2D is a schematic top shadow view of the feed stalk printed circuit board of FIG. 2B.

FIG. 2E is a schematic front shadow view of the mid-band cross-dipole radiating element of FIG. 2A.

FIG. 2F is a schematic rear shadow view of the mid-band cross-dipole radiating element of FIG. 2A.

FIG. 3A is a schematic front view of a modified version of the mid-band cross-dipole radiating element of FIG. 2A.

FIG. 3B is a graph comparing the cross-polarization isolation performance of the radiating elements of FIGS. 2A and 3A.

FIG. 4 is a schematic front shadow view of a mid-band radiating element according to further embodiments of the present invention.

FIGS. 5A-5C are schematic front shadow views of dipole radiator printed circuit boards of mid-band radiating elements according to additional embodiments of the present invention.

FIGS. 6A and 6B are schematic front perspective shadow views of mid-band radiating elements according to yet additional embodiments of the present invention.

FIG. 7A is a schematic front shadow view of a mid-band radiating element according to still further embodiments of the present invention.

FIGS. 7B-7D are enlarged schematic front shadow views of a corner of the mid-band radiating element of FIG. 7A that illustrates the current distribution on the radiating element in response to different types of higher-band radiation.

Several of the figures are “shadow” views of printed circuit boards included in the radiating elements according to embodiments of the invention. In these shadow views, the dielectric substrate of the printed circuit board is made transparent to show portions of the metallization pattern on the far side of the printed circuit board that are not covered by the metallization pattern on the near side of the printed circuit board.

### DETAILED DESCRIPTION

The above-described passive/active antenna systems allow a cellular operator to support both legacy 2G/3G/4G cellular service and 5G cellular service using a single base station antenna. Unfortunately, however, in practice the radiating elements of the passive 2G/3G/4G arrays that are mounted in front of the 5G beamforming array can cause “scattering” of the RF radiation generated by the 5G beamforming array. Scattering is undesirable as it may reduce the gain of the 5G antenna beams by changing the shape thereof in both the azimuth and elevation planes. For example, scattering tends to negatively impact the beamwidth, beam shape, pointing angle, gain and front-to-back ratio of the 5G antenna beams.

Two different types of scattering can occur. First, conductive structures of the radiating elements of the lower frequency (passive) linear arrays that are mounted in front of the 5G beamforming array can reflect RF energy transmitted by the radiating elements of the beamforming array. Some of this reflected RF energy may then exit the base station antenna in undesired directions (potentially after further reflecting off of other metal structures in the base station antenna such as the reflector, etc.) or may exit the base station antenna in a desired direction but with a phase that causes the reflected RF energy to destructively combine with non-reflected RF energy. The net result is that when RF energy emitted by the beamforming array reflects off the radiating elements of the passive 2G/3G/4G linear arrays, these reflections generally act to distort the radiation pattern generated by the beamforming array in undesirable ways.

The second type of scattering occurs when a conductive structure of the radiating elements of the passive 2G/3G/4G linear arrays has an electrical length that makes the structure resonant in the operating frequency band of the 5G beamforming array. A conductive structure of a radiating element of one of the passive (lower frequency band) arrays may be resonant in the operating frequency band of the 5G (higher frequency band) beamforming array if, for example, the conductive structure has an electrical length that is about ½ a wavelength or about a full wavelength of a frequency within the operating frequency band of the 5G beamforming array. In many cases, the operating frequency band of the beamforming array may be about twice frequencies within the operating frequency band of the passive mid-band linear arrays. Since, for example, the dipole arms of the radiating elements of the high-band linear arrays typically have an electrical length of about ¼ of a center wavelength of the mid-band operating frequency range, they may have a resonant length with respect to RF energy emitted by the 5G beamforming array. As such, RF energy transmitted by the 5G beamforming array may couple to, for example, the dipole arms of nearby mid-band radiating elements, and the higher-band currents formed on these dipole arms generates additional high-band radiation that distorts the high-band antenna beams (since some of the RF energy is being emitted from unintended locations, namely from the mid-band dipole arms).

One way to prevent the mid-band radiating elements from distorting the antenna beams generated by the high-band beamforming array is to position the mid-band linear arrays in one part of a passive/active antenna system (e.g., the lower portion) and to position the high-band beamforming array in a different part of the passive/active antenna system (e.g., the upper portion). However, since cellular operators typically have strict limits on the acceptable lengths for different types of base station antennas, spatially offsetting the mid-band linear arrays from the high-band beamforming array often places a limit on the length of the mid-band linear arrays. Since the gain of a linear array is a function of a length of the array, this approach may limit the maximum gain of the mid-band linear arrays (and/or of the high-band beamforming array).

In order to increase the gain of the mid-band linear arrays, the length of some or all of the mid-band linear arrays may be increased so that mid-band radiating elements are mounted beside and/or in front of the high-band beamforming array. However, the mid-band radiating elements that are mounted in front of the high-band beamforming array may cause both types of scattering discussed above, and mid-band radiating elements that are mounted beside a high-band beamforming array may cause both types of scattering when the high-band antenna beams are scanned in the direction of the mid-band radiating elements. Thus, while increasing the length of the mid-band linear arrays may improve the gain thereof, the longer mid-band linear arrays may cause scattering of the high-band antenna beams, which can degrade the gain, beamwidth, and beam shape of the high-band antenna beams.

So-called “cloaked” or “cloaking” radiating elements are known in the art that have dipole arms that are designed so that currents will largely not form thereon in response to RF radiation in pre-selected frequency ranges (e.g., currents in the operating frequency band of the high-band radiating elements in the 5G beamforming array). These radiating elements can reduce the second type of scattering discussed above but typically do not reduce the first type of scattering.

Pursuant to embodiments of the present invention, mid-band radiating elements are provided that may have reduced impact on the antenna beams of the high-band beamforming array. The mid-band radiating elements according to embodiments of the present invention may have dipole radiators that are cloaked with respect to RF radiation in the operating frequency band of the high-band beamforming array. This may significantly reduce the extent to which high-band currents form on the mid-band dipole arms, thereby suppressing the first type of high-band RF radiation scattering discussed above. In addition, the mid-band radiating elements according to embodiments of the present invention may include a single feed stalk printed circuit board that is positioned parallel to the scan direction of the high-band beamforming array. This may significantly reduce the extent to which the feed stalks of the mid-band radiating elements reflect the high-band RF radiation, thereby suppressing the second type of high-band RF radiation scattering discussed above. The mid-band radiating elements also may not include any directors, which further reduces scattering of the high-band radiation. Via these techniques, the mid-band radiating elements according to embodiments of the present invention may only have a small impact on the high-band antenna beams (e.g., an average reduction in directivity of about 0.1 dB).

Unfortunately, when a dual-polarized radiating element includes a single feed stalk printed circuit board that includes RF transmission lines for each polarization, an unbalance may arise that may degrade the cross-polarization isolation of the dual-polarized radiating elements. In order to counteract this unbalance, the dipole arms of the mid-band radiating elements according to embodiments of the present invention may have asymmetric couplings with adjacent dipole arms, where the asymmetric couplings are designed to compensate for the unbalance. As a result, the radiating elements according to embodiments of the present invention may only include a single feed stalk printed circuit board while still exhibiting a high degree of cross-polarization isolation. The dipole arms may counteract the unbalance in the feed stalk by, for example, having distal ends of the inner sides of selected of the dipole arms be positioned to exhibit increased coupling.

The radiating elements according to embodiments of the present invention may comprise first through fourth dipole arms and first through fourth metal cloaking structures that are mounted to overlap the respective first through fourth dipole arms. Each metal cloaking structure may be capacitively coupled to a respective one of the dipole arms and may form one or more resonant circuits with the dipole arm. These resonant circuits may be configured to cloak the dipole arms with respect to RF radiation in an operating frequency band of a different array of radiating elements that are included in a base station antenna that includes the radiating elements according to embodiments of the invention. The radiating elements may include couplings (e.g., capacitive or inductive couplings) between selected ones of the dipole arms that counteract the unbalance in the feed stalk.

Pursuant to further embodiments of the present invention, cross-dipole radiating elements are provided in which the dipole arms are implemented as metal loops. A plurality of outwardly-extending slots are provided in the inner sides of the conductive loops and a plurality of inwardly-extending slots are provided in the outer sides of the metal loops. The inwardly-extending and outwardly-extending slots may be alternating so that each outwardly-extending slot may be adjacent at least one, and typically two, inwardly-extending slots, and so that each inwardly-extending slot may be adjacent at least one, and typically two, outwardly-extending slots. The slots may significantly increase the length of the current path along each dipole arm, which allows the overall size of the dipole arm (namely the length of the perimeter of the dipole arm when viewed from the front) to be reduced while still maintaining an appropriate electrical length for operation as a mid-band radiating element. The reduced size of these radiating elements may further reduce the impact that the mid-band radiating elements according to embodiments of the present invention have on the radiation patterns of nearby high-band radiating elements.

Pursuant to further embodiments of the present invention, base station antennas are provided that include one or more linear arrays of the above described mid-band radiating elements. The base station antenna may be, for example, a passive base station antenna of a passive/active antenna system.

Before discussing the radiating elements according to embodiments of the present invention it is helpful to discuss the design and operation of an example base station antenna in which the radiating elements according to embodiments of the present invention may be used.

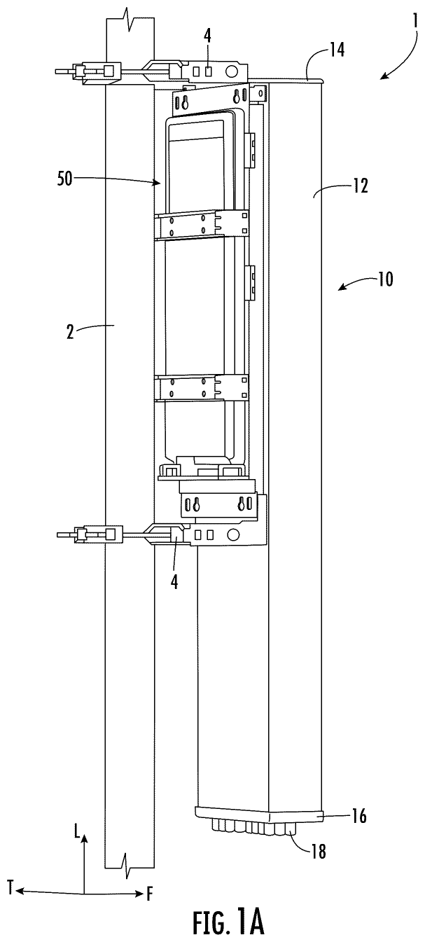

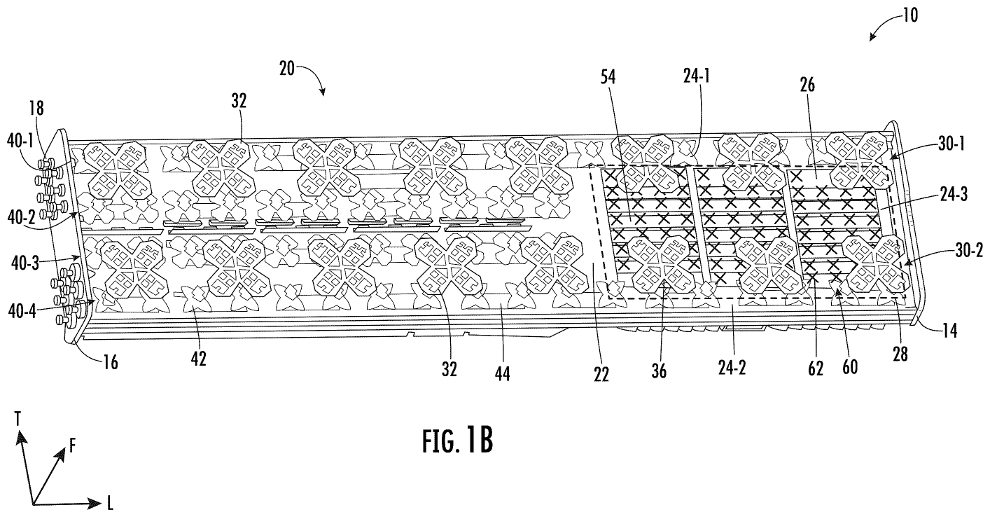

FIGS. 1A-1B illustrate a conventional base station antenna in the form of a passive/active antenna system 1 that includes both a passive base station antenna 10 and an active antenna module 50. In particular, FIG. 1A is a schematic rear perspective view of the passive/active antenna system 1, while FIG. 1B is a schematic perspective view of the passive/active antenna system 1 of FIG. 1A with a frequency selective surface and radomes of both the passive base station antenna 10 and the active antenna module 50 omitted. In FIGS. 1A and 1B, the axes illustrate the longitudinal (L), transverse (T) and forward (F) directions of the passive/active antenna system 1. In the description that follows, the passive/active antenna system 1 and the radiating elements included therein will be described using terms that assume that the passive/active antenna system 1 is mounted for normal use on a tower with a longitudinal axis of the passive/active antenna system 1 extending along a vertical axis and the front surface of the passive/active antenna system 1 mounted opposite the tower pointing toward the coverage area for the antenna 1.

Referring to FIG. 1A, the passive/active antenna system 1 may be mounted, for example, on an antenna tower 2 using mounting hardware 4. The active antenna module 50 may be mounted directly on a rear surface of the passive base station antenna 10, or may be held in place behind the passive base station antenna 10 by the mounting hardware 4. The front surface of the passive/active antenna system 1 may be opposite the antenna tower 2 facing toward a coverage area of the passive/active antenna system 1. The passive base station antenna 10 includes a tubular radome 12 that surrounds and protects an antenna assembly that is mounted inside the radome 12. A top end cap 14 covers a top opening in the radome 12 and a bottom end cap 16 covers a bottom opening in the radome 12. A plurality of RF ports 18 extend through the bottom end cap 16 and are used to connect the passive base station antenna 10 to one or more external radios (not shown). The active antenna module 50 may be removably mounted behind the passive base station antenna 10 so that the active antenna module 50 may later be replaced with a different active antenna module.

Referring to FIG. 1B, the passive base station antenna 10 includes a reflector assembly 20. The reflector assembly 20 may be referred to herein as a “passive reflector assembly” since it is part of the passive base station antenna 10. The passive reflector assembly 20 includes a main reflector 22 and spaced-apart first and second reflector strips 24-1, 24-2 that extend longitudinally from respective first and second opposed sides of the main reflector 22. It should be noted that herein like elements may be referred to individually by their full reference numeral (e.g., reflector strip 24-1) and may be referred to collectively by the first part of their reference numeral (e.g., the reflector strips 24). The passive reflector assembly 20 may further include a third reflector strip 24-3 that extends in a transverse direction between top ends of the first and second reflector strips 24-1, 24-2. An opening 26 is defined between the first and second reflector strips 24-1, 24-2. For example, the opening 26 may be bounded by a top portion of the main reflector 22, the first and second reflector strips 24-1, 24-2, and the third reflector strip 24-3. At least the main reflector 22 may comprise or include a metallic surface (e.g., a sheet of aluminium) that serves as a reflector and ground plane for the radiating elements of the antenna 1. Various mechanical and electronic components of the antenna (not shown) may be mounted behind the passive reflector assembly 20 such as, for example, phase shifters, remote electronic tilt units, mechanical linkages, controllers, diplexers, and the like. The frequency selective surface 28 is not shown in FIG. 1B to show elements that are mounted behind the frequency selective surface 28. A dashed box (labelled 28) is provided in FIG. 1B that shows the location where the is frequency selective surface 28 mounted.

A frequency selective surface 28 is provided that overlaps and/or covers the opening 26. A frequency selective surface is a conductive (usually metal) structure that is designed to have frequency selective responses with respect to RF radiation that is incident thereon. For example, a frequency selective surface may be designed to partially or substantially pass RF energy in a first frequency band while substantially reflecting RF energy in a second different frequency band, thereby acting as a spatial filter. The frequency selective surface 28 may be coplanar with the opening 26 or mounted either in front of or behind the opening 26. In some cases, the opening 26 may be omitted and a large number of small openings may be stamped in the main reflective surface 22 (in the position of the opening 26) to form the frequency selective surface 28 in the main reflective surface 22.

The frequency selective surface 28 may be configured to allow RF energy emitted by the radiating elements of a high-band beamforming array (discussed below) that is included in the active antenna module 50 to pass therethrough, while the frequency selective surface 28 reflects RF energy in the operating frequency bands of low-band and mid-band radiating elements (discussed below) that are included in the passive base station antenna 10. The frequency selective surface 28 can have a grid pattern such as a grid of metal patches and/or other metal structures that form a plurality of periodically arranged unit cells. The grid pattern can be arranged in any suitable manner and may be symmetric or asymmetric across a width and/or length of the frequency selective surface 28. The grid pattern may comprise sub-wavelength periodic microstructures. The unit cells may include inductive and/or capacitive structures that couple with each other or with the inductive and/or capacitive structures of adjacent unit cells so that the frequency selective surface 28 is an LC resonant circuit. The LC resonant circuit may be designed to be more transparent to RF energy in a first frequency range than in a second frequency range. A general discussion of frequency selective surfaces may be found in Ben A. Munk, Frequency Selective Surfaces: Theory and Design, ISBN: 978-0-471-37047-5; DOI: 10.1002/0471723770; April 2000, Copyright @ 2000 John Wiley & Sons, Inc. the contents of which are hereby incorporated by reference as if recited in full herein.

The passive base station antenna 10 further includes a plurality of passive linear arrays of radiating elements that extend forwardly from the passive reflector assembly 20. The linear arrays may support, for example, 2G, 3G and/or 4G cellular service. In the example passive base station antenna 10 shown in FIGS. 1A-1B, the linear arrays include first and second low-band linear arrays 30-1, 30-2 that are configured to operate in all or part of the 617-960 MHz frequency band. Each low-band linear array 30 comprises a vertically-extending column of low-band radiating elements 32. The passive base station antenna 10 further includes first through fourth mid-band linear arrays 40-1 through 40-4 that are configured to operate in all or part of the 1427-2690 MHz frequency band. Each mid-band linear array 40 comprises a vertically-extending column of mid-band radiating elements 42. Each of the low-band and mid-band linear arrays 30, 40 may generate relatively static antenna beams that provide coverage to a predefined coverage area (e.g., antenna beams that are each configured to cover a sector of a base station), with the only change to the coverage area occurring when the electronic downtilt angles of the generated antenna beams are adjusted (e.g., to change the size of the cell).

Each of the low-band and mid-band radiating elements 32, 42 may be implemented as dual-polarized radiating elements that include first and second radiators that transmit and receive RF energy at orthogonal polarizations. When such dual-polarized radiating elements are used, each of the low-band and mid-band linear arrays 30, 40 may be connected to a pair of the RF ports 18. The first RF port 18 is connected between a first port of a radio (e.g., a remote radio head) and the first polarization radiators of the radiating elements in one of the linear arrays, and the second RF port 18 is connected between a second port of a radio and the second polarization radiators of the radiating elements in the linear array. RF signals that are to be transmitted by a selected one of the linear arrays 30, 40 are passed from the radio(s) to one of the RF ports 18, and passed from the RF port 18 to a power divider (or, alternatively, a phase shifter assembly that includes a power divider) that divides the RF signal into a plurality of sub-components that are fed to the respective first or second radiators of the radiating elements in the linear array, where the sub-components of the RF signal are radiated into free space.

The low-band and/or mid-band radiating elements 32, 42 may be mounted on feed board printed circuit boards that couple RF signals to and from the individual radiating elements 32, 42. In FIG. 1B, the mid-band radiating elements 42 are shown as being mounted in pairs on a plurality of mid-band feed board printed circuit boards 44 (the low-band radiating elements are likewise mounted on feed board printed circuit boards but they are not visible in the figure). Cables may be used to connect each feed board printed circuit board 44 to other components of the antenna such as diplexers, phase shifters or the like.

Most of the low-band and mid-band radiating elements 32, 42 are mounted to extend forwardly from the main reflector 22. However, low-band linear arrays 30-1, 30-2 extend substantially the full length of the passive/active antenna system 1 and hence extend beyond (above) the main reflector 22. The first and second reflector strips 24-1, 24-2 provide mounting locations for low-band radiating elements 32 that are positioned above the main reflector 22. The first and second reflector strips 24-1, 24-2 may be integral with the main reflector 22 so that the first and second reflector strips 24-1, 24-2 and the main reflector 22 will be maintained at a common ground voltage, which may improve the performance of the low-band linear arrays 30-1, 30-2. Similarly, mid-band linear arrays 40-1, 40-4 extend beyond (above) the main reflector 22 with the first and second reflector strips 24-1, 24-2 also providing mounting locations for the mid-band radiating elements 42 that are positioned above the main reflector 22.

Each low-band radiating element 32 and mid-band radiating element 42 may comprise a slant −45°/+45° cross-dipole radiating element that includes a slant −45° polarization dipole radiator and a slant +45° polarization dipole radiator. The dipole radiators may be mounted on a feed stalk (not visible). In the antenna 1, the low-band and mid-band radiating elements 32, 42 that are mounted above the main reflector 22 are mounted on the reflector strips 24-1, 24-2. It will be appreciated that in other passive/active antenna systems the low-band radiating elements 32 and/or the mid-band radiating elements 42 may instead be mounted on the frequency selective surface 28.

The active antenna module 50 includes a multi-column beamforming array 60 of radiating elements 62 and a beamforming radio (not visible in the figures). The multi-column beamforming array 60 may be mounted in a forward portion of the active antenna module 50 behind the frequency selective surface 28. The beamforming radio may be mounted behind the multi-column beamforming array 60. The beamforming array 60 may, for example, comprise a plurality of vertically-extending columns of high-band radiating elements 62 that are configured to operate in all or part of the 3.1-4.2 GHz frequency band (e.g., in the 3.4-4.0 GHz frequency band). The high-band radiating elements 62 are mounted to extend forwardly from a reflector 54 of the active antenna module 50 (herein the “active reflector”). The beamforming radio is capable of electronically adjusting the amplitude and/or phase of the subcomponents of an RF signal that are output to different radiating elements 62 of the multi-column beamforming array 60. For example, each port of the beamforming radio may be coupled to a column of radiating elements of the beamforming array 60, and the amplitudes and phases of the sub-components of the RF signals that are fed to each column may be adjusted so that the generated antenna beams are narrowed in the azimuth plane and pointed in a desired direction in the azimuth plane.

As noted above, the beamforming array 60 of active antenna module 50 is mounted behind the frequency selective surface 28. The beamforming array 60 is visible in FIG. 1B as the frequency selective surface 28 and the radome of the passive base station antenna 10 are omitted in FIG. 1B, as is the radome of the active antenna module 50. The opening 26 in the passive reflector assembly 20 and the frequency selective surface 28 allow the antenna beams generated by the beamforming array 60 to pass through the reflector assembly 20 to provide service to the coverage area of the passive/active antenna system 1. The frequency selective surface 28 acts as a reflector to RF radiation in the low-band and mid-band frequency ranges.

One difficulty with the passive/active antenna system 1 of FIGS. 1A-1B is that the top four mid-band radiating elements 42 in mid-band linear arrays 40-1 and 40-4 are mounted on the respective reflector strips 24-1, 24-2. As such, when the antenna beams that are generated by the high-band beamforming array 60 are scanned in the azimuth plane, a substantial amount of the high-band RF radiation may impinge on these mid-band radiating elements 42. Moreover, in some cases, the mid-band linear arrays 40-2, 40-3 may be lengthened so that some of the mid-band radiating elements 42 in these mid-band linear arrays 40-2, 40-3 are mounted directly in front of the high-band beamforming array 60 (e.g., mounted on the frequency selective surface 28). As such, the mid-band linear arrays 40-1 through 40-4 may distort the antenna beams generated by the high-band beamforming array 60.

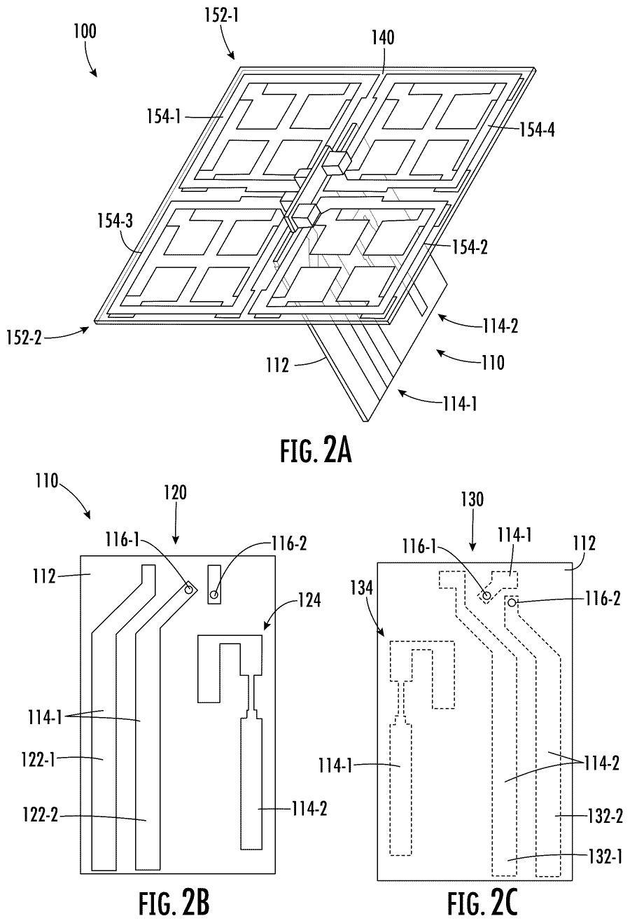

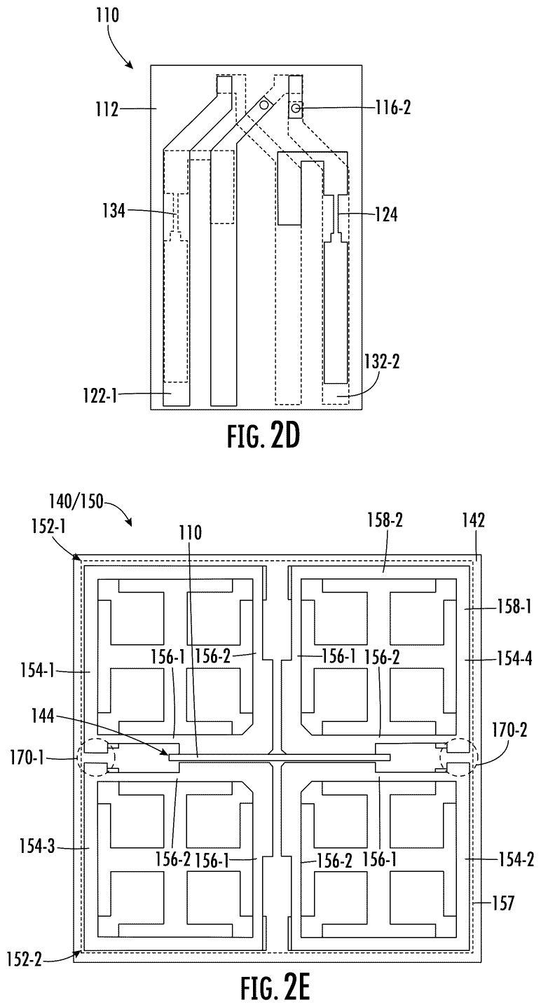

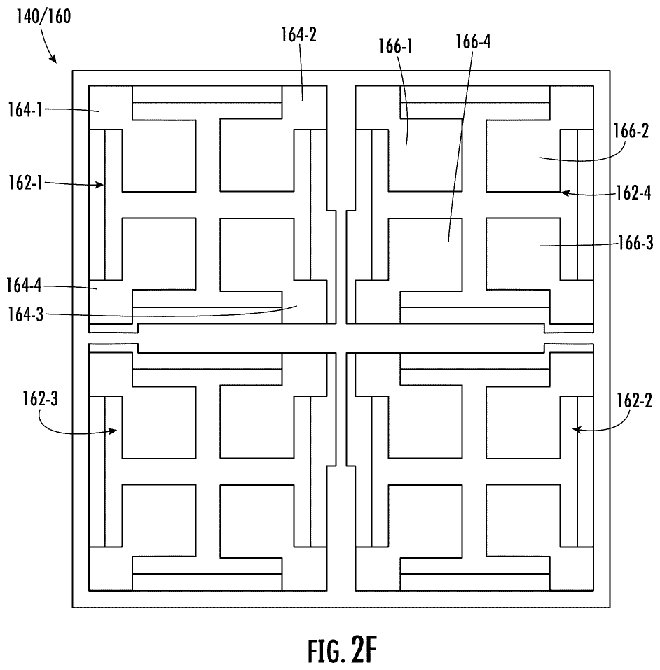

FIGS. 2A-2F illustrate a mid-band cross-dipole radiating element 100 according to embodiments of the present invention. In particular, FIG. 2A is a schematic perspective view of the mid-band cross-dipole radiating element 100, while FIGS. 2B and 2C are schematic front and rear views a feed stalk printed circuit board of mid-band radiating element of 100, and FIG. 2D is a schematic front shadow view of the feed stalk printed circuit board. Finally, FIGS. 2E and 2F are schematic front and rear shadow views of mid-band radiating element of 100. In FIG. 2D, the solid lines illustrate the metallization pattern on the first side of the feed stalk printed circuit board and the dashed lines illustrate the metallization pattern on the second (opposed) side of the feed stalk printed circuit board. The mid-band cross-dipole radiating element 100 may, for example, be used to implement at least some of the mid-band radiating elements 42 included in passive/active antenna system 1.

As shown in FIG. 2A, the mid-band cross-dipole radiating element 100 includes a feed stalk 110 and a dipole radiator printed circuit board 140 that has first and second dipole radiators 152-1, 152-2 formed therein. The dipole radiator printed circuit board 140 is mounted adjacent (and typically on) the distal end of a feed stalk 110. The mid-band cross-dipole radiating element 100 does not include any director.

Referring to FIGS. 2A-2D, the feed stalk 110 comprises a single feed stalk printed circuit board 110 that includes a dielectric substrate 112 with first and second metallization patterns 120, 130 formed on the two major surfaces thereof. First and second RF transmission lines 114-1, 114-2 are formed in the feed stalk printed circuit board 110. These RF transmission lines 114-1, 114-2 carry RF signals between first and second RF transmission lines (not shown) of a feed network and the respective dipole radiators 152-1, 152-2.

As shown in FIG. 2B, the first metallization pattern 120 primarily includes a pair of ground lines 122-1, 122-2 that form a twin ground line structure of the first RF transmission line 114-1 and a hook balun 124 that comprises the signal trace of the second RF transmission line 114-2. As shown in FIG. 2C, the second metallization pattern 130 primarily includes a pair of ground lines 132-1, 132-2 that form a twin ground line structure of the second RF transmission line 114-2 and a hook balun 134 that comprises the signal trace of the first RF transmission line 114-1.

A rear end (base) of each ground line 122-1, 122-2 is coupled to the ground conductor of the first RF transmission line of the feed network for radiating element 100 (not shown). A rear end of the signal trace 134 is coupled to the signal conductor of the first RF transmission line of the feed network for radiating element 100. Similarly, a rear end of each ground line 132-1, 132-2 is coupled to the ground conductor of the second RF transmission line of the feed network for radiating element 100 (not shown), and a rear end of the signal trace 124 is coupled to the signal conductor of the second RF transmission line of the feed network for radiating element 100. Each ground line 122, 132 may each have an electrical length of about ¼ the wavelength corresponding to the center frequency of the operating frequency band of radiating element 100. As is further shown, a first plated through hole 116-1 is provided that extends through dielectric substrate 112 that allows the forward end of ground line 122-2 to transition to the opposite side of the dielectric substrate 112 (to be part of metallization pattern 130) so that ground line 122-2 is in the proper position to be soldered to one of the dipole arms (discussed below) of dipole radiator 152-1. Similarly, a plated through hole 116-2 is provided that extends through dielectric substrate 112 that allows the forward end of ground line 132-2 to transition to the opposite side of the dielectric substrate 112 (to be part of metallization pattern 120) so that ground line 132-2 is in the proper position to be soldered to one of the dipole arms (discussed below) of dipole radiator 152-2.

Referring to FIGS. 2E and 2F, the dipole radiator printed circuit board 140 includes a dielectric substrate 142 with first and second metallization layers 150, 160 formed on the two major surfaces thereof. The dielectric substrate 142 has a square shape in the depicted embodiment. The first dipole radiator 152-1 extends along a first axis (a −45° axis) and the second dipole radiator 152-2 extends along a second axis (a +45° axis) that is generally perpendicular to the first axis. The first dipole radiator 152-1 includes first and second dipole arms 154-1, 154-2, and the second dipole radiator 152-2 includes third and fourth dipole arms 154-3, 154-4.

Dipole arms 154-1 and 154-2 of first dipole radiator 152-1 are center fed by the first RF feed line 114-1 and radiate together at a first polarization, which here is a slant-450 linear polarization. Dipole arms 154-3 and 154-4 of second dipole radiator 152-2 are center fed by the second RF feed line 114-2 and radiate together at a second polarization that is orthogonal to the first polarization, which here is a slant +45° linear polarization

As shown best in FIG. 2E, each dipole arm 154 is formed as a generally square shaped annular conductive loop. The first and second dipole radiators 152-1, 152-2 are arranged to cross one another so that the four dipole arms 154 are positioned in the four quadrants of the square 157 defined by dielectric substrate 142. Each dipole arm 154 thus includes two “inner” sides 156-1, 156-2 that extend from a center of the dipole radiator printed circuit board 140 to two different edges thereof, and two “outer” sides 158-1, 158-2 that extend along respective edges of the square 157 defined by the dipole arms 154. Portions of the inner sides 156-1, 156-2 of each dipole arm 154 are widened as compared to the majority of each dipole arm 154. Widening these portions of the dipole arms 154 may improve the impedance match between the dipole arms 154 and the RF transmission lines 114 on feed stalk printed circuit board 110.

The dipole radiator printed circuit board 140 includes an opening therethrough in the form of a slot 144. A forward end of the feed stalk printed circuit board 110 may extend through the slot 144. Since only a single feed stalk printed circuit board 110 is provided, the interface between the feed stalk printed circuit board 110 and the dipole radiator printed circuit board 140 may be unbalanced. As shown, the feed stalk printed circuit board 110 is positioned between the first dipole arm 154-1 and the third dipole arm 154-3 and between the second dipole arm 154-2 and the fourth dipole arm 154-4. It has been discovered that the unbalance introduced by the single feed stalk printed circuit board 110 may degrade the isolation between dipole radiators 152-1, 152-2 (i.e., the unbalance design may degrade the cross-polarization isolation of radiating element 100). In order to counteract this unbalance, the distal end of one (but not both) of the inner sides 156 of each dipole arm 154 is widened so that it extends close to an adjacent dipole arm 154. In particular, the inner side 156-1 of the first dipole arm 154-1 extends closer to the inner side 156-2 of the third dipole arm 154-3, and the inner side 156-1 of the second dipole arm 154-2 extends closer to the inner side 156-2 of the fourth dipole arm 154-4. The facing widened portions at distal ends of the inner sides 156 of facing dipole arms 154 form a pair of capacitors 170-1, 170-2 that counteract the above described unbalance resulting from the use of a single feed stalk printed circuit board 110. A plane defined by the dielectric substrate 142 of dipole radiator printed circuit board 140 may intersect the first capacitor 170-1 and the second capacitor 170-2.

In the depicted embodiments, the dipole arms 154 themselves do not include any cloaking structures. Instead, mid-band radiating element 100 includes a plurality of metal cloaking structures 162 that are implemented in the second metallization pattern 160 of dipole radiator printed circuit board 140. Each metal cloaking structure 162 is formed behind a respective one of the dipole arms 154. Each metal cloaking structure 162 comprises four small metal pads 164-1 through 164-4 that overlap the four corners of the dipole arm 154 so that each small metal pad 164 is capacitively coupled to the dipole arm 154. Herein, a first element on a printed circuit board “overlaps” a second element if an axis that is perpendicular to a major surface of the printed circuit board passes through both the first and second elements. Each metal cloaking structure 162 further comprises four larger metal pads 166-1 through 166-4. Each larger metal pads 166 is galvanically connected to a respective one of the smaller metal pads 164. These connections are formed at the corners of the smaller and larger metal pads through 164, 166 so that a relatively narrow strip of metal connects the smaller metal pad 164 to the larger metal pad 166, providing a series inductance. Two sides of each larger metal pad 166 also edge couple with a respective one of the dipole arms 154. These inductive and capacitive couplings form a plurality of resonant circuits which may, for example, be formed electrically in series. These resonant circuits are configured to pass RF currents in the operating frequency band of the radiating element 100 while suppressing RF currents in a different frequency band. The different frequency band may be an operating frequency band of another array of radiating elements included in the base station antenna that includes radiating element 100. Thus, the metal cloaking structures 162 allow the dipole arms 154 to be non-cloaked structures while still ensuring that the radiating element 100 is cloaked with respect to RF radiation in an operating frequency band of a nearby higher frequency band radiating element. Of course, it is also possible to include cloaking structures in the dipole arms 154 to provide a higher degree of cloaking.

Each metal cloaking structure 162 may include multiple resonant circuits. For example, each combination of a smaller metal pad 164 and a larger metal pad 166 may form a resonant circuit with a dipole arm 154. These resonant circuits may be electrically disposed in series and/or in parallel. While radiating element 100 includes metal cloaking structures 162 that operate by forming resonant circuits with the dipole arms, it will be appreciated that in other embodiments the metal cloaking structures 162 may be implemented using metamaterial surfaces having a periodic arrangement that perform the cloaking function.

The mid-band radiating element 100 may exhibit a high degree of transparency to RF radiation in, for example, the 3.4-4.0 GHz frequency range. The single feed stalk printed circuit board 110 has relatively little metallization, and is mounted so that the major surfaces thereof extend in the forward F and transverse T directions when the radiating element 100 is mounted in passive/active antenna system 1. Thus, when the high-band beamforming array 160 is electronically scanned in the azimuth plane (i.e., the antenna beams are scanned in the transverse direction T), the antenna beams impinge on the thin side surfaces of the feed stalk printed circuit board 110 and hence mostly do not “see” the metallization patterns 120, 130 on the feed stalk printed circuit board 110. The mid-band radiating elements 100 also do not include any director that may otherwise reflect high-band RF radiation. Finally, the cloaking structures 162 cloak the dipole arms 154 so that high-band RF radiation will, for the most part, simply pass through the dipole radiator printed circuit board 140. Simulations indicate that the directivity of the high-band beamforming array 160 only drops by about 0.1 dB (on average across the 3.4-4.0 GHz operating frequency range) when the mid-band radiating elements 100 are positioned in front of the high-band beamforming array 160 in passive/active base station antenna 1.

Referring again to FIGS. 2A-2F, pursuant to embodiments of the present invention, a radiating element 100 is provided that includes a feed stalk printed circuit board 110 that comprises a first RF transmission line 114-1 and a second RF transmission line 114-2. The radiating element 100 further includes a first dipole radiator 152-1 that is coupled to the first RF transmission line 114-1, the first dipole radiator 152-1 comprising a first dipole arm 154-1 and a second dipole arm 154-2, and a second dipole radiator 152-2 that is coupled to the second RF transmission line 114-2, the second dipole radiator 152-2 comprising a third dipole arm 154-3 and a fourth dipole arm 154-4. The feed stalk printed circuit board 110 is positioned between the first dipole arm 152-1 and the third dipole arm 152-3 and between the second dipole arm 152-2 and the fourth dipole arm 152-4.

Each of the dipole arms 154 may comprise a metal loop having an open interior. Each of the dipole arms 154 is positioned next to two other of the dipole arms 154 so that the four dipole arms 154 together define a square 157 when viewed from the front. Each of the dipole arms 154 has a first inner side 156-1 and a second inner side 156-2 that each extend outwardly from a center of the square and a first outer side 158-1 and a second outer side 158-2 that each define a respective portion of a periphery of the square 157. A first amount of coupling between the first dipole arm 154-1 and the third dipole arm 154-3 exceeds a second amount of coupling between the first dipole arm 154-1 and the fourth dipole arm 154-4. Likewise, a third amount of coupling between the second dipole arm 152-2 and the fourth dipole arm 152-4 exceeds a fourth amount of coupling between the second dipole arm 152-2 and the third dipole arm 152-3. The difference between the first amount of coupling and the second amount of coupling may be provided by a first capacitor 170-1 that is provided between a distal end of the first inner side 156-1 of the first dipole arm 154-1 and a distal end of the second inner side 156-2 of the third dipole arm 154-3. The difference between the third amount of coupling and the fourth amount of coupling may be provided by a second capacitor 170-2 that is provided between a distal end of the first inner side 156-1 of the second dipole arm 154-2 and a distal end of the second inner side 156-2 of the fourth dipole arm 154-4. The capacitors 170 may be configured to improve isolation between the two dipole radiators 152.

The radiating element 100 may be one of a plurality of lower frequency band radiating elements that are included in a base station antenna such as passive/active antenna system 1. For example, some or all of the mid-band arrays 140 may be implemented using radiating element 100. The beamforming array 160 of higher frequency band radiating elements 162 is mounted rearwardly of the radiating element 100. The radiating element 100 may further comprise first through fourth metal cloaking structures 162-1 through 162-4 that overlap the respective first through fourth dipole arms 154-1 through 154-4, where the metal cloaking structures 162 are configured to render the respective dipole arms 154 substantially transparent to RF radiation emitted by the higher frequency band radiating elements 162. The dipole arms 154 and the metal cloaking structures 162 may each be formed on a dielectric substrate 142 of a dipole radiator printed circuit board 140. The array 160 of higher frequency band radiating elements 162 may be a multi-column array with the columns extending in a longitudinal direction of the antenna 1, and first and second major surfaces of the feed stalk printed circuit board 110 may extend forwardly from a reflector 122 of the antenna 1 and perpendicular to the longitudinal direction.

Still referring to FIGS. 2A-2F, the mid-band radiating element 100 comprises a feed stalk printed circuit board 110 that includes first and second RF transmission lines 114-1, 114-2, a first dipole radiator 152-1 that is coupled to the first RF transmission line 114-1, the first dipole radiator 152-1 comprising first and second dipole arms 154-1, 154-2, and a second dipole radiator 152-2 that is coupled to the second RF transmission line 114-2, the second dipole radiator 152-2 comprising third and fourth dipole arms 154-3, 154-4. The feed stalk printed circuit board 110 is positioned between the first dipole arm 154-1 and the third dipole arm 154-3 and between the second dipole arm 154-2 and the fourth dipole arm 154-4. Distal ends of facing inner sides 156 of the first and third dipole arms 154-1, 154-3 are spaced more closely together than distal ends of facing inner sides 156 of the first and fourth dipole arms 154-1, 154-4. Distal ends of facing inner sides 156 of the second and fourth dipole arms 154-2, 154-4 may also be spaced more closely together than distal ends of facing inner sides 156 of the second and third dipole arms 154-2, 154-3. The inner sides 156 of the first and third dipole arms 154-1, 154-3 that face each other are symmetric about a first axis and the inner sides 156 of the first and fourth dipole arms 154-1, 154-4 that face each other are symmetric about a second axis. Similarly, inner sides 156 of the second and fourth dipole arms 154-2, 154-4 that face each other are symmetric about the first axis and inner sides 156 of the second and third dipole arms 154-2, 154-3 are symmetric about the second axis. The feed stalk printed circuit board 110 may extend along the first axis.

As can also be seen from FIGS. 2A-2F, the mid-band radiating element 100 comprises a first dipole radiator 152-1 that includes first and second dipole arms 154-1, 154-2 and a second dipole radiator 152-2 that includes a third dipole arm and a fourth dipole arm 154-3, 154-4. The radiating element 100 further include first through fourth metal cloaking structures 162-1 through 162-4 that form resonant circuits with the respective first through fourth dipole arms 154-1 through 154-4. These resonant circuits may be configured to allow currents in the operating frequency band of radiating element 100 to flow on the dipole arms 154 while blocking currents in another operating frequency band from flowing on the dipole arms 154. A first amount of coupling between the first dipole arm 154-1 and the third dipole arm 154-3 exceeds a second amount of coupling between the first dipole arm 154-1 and the fourth dipole arm 154-4.

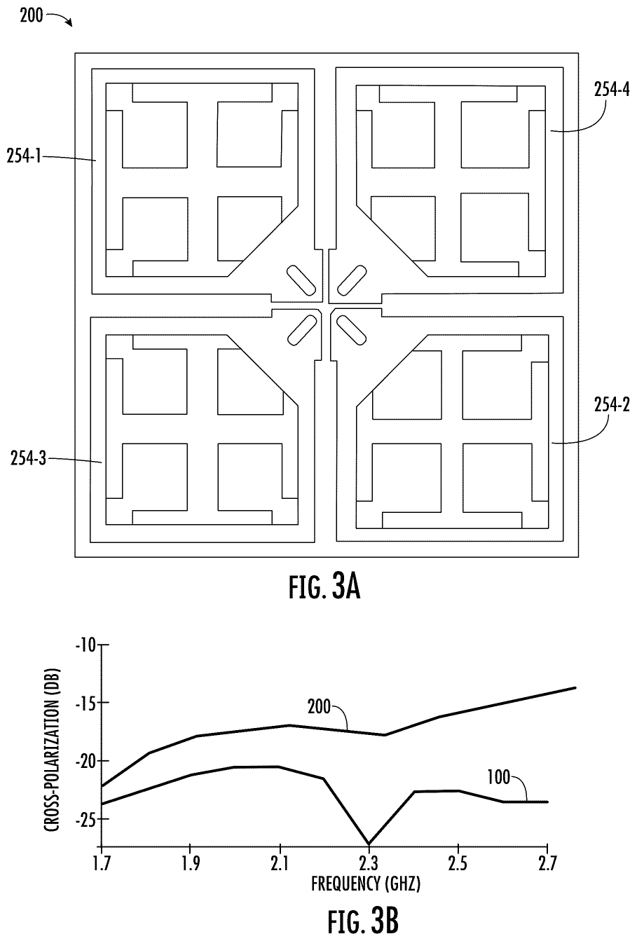

FIG. 3A is a schematic front view of a mid-band cross-dipole radiating element 200 that is a modified version of the mid-band cross-dipole radiating element 100 of FIGS. 2A-2F. As can be seen by comparing FIGS. 2A and 3A, radiating element 200 is similar to radiating element 100, but radiating element 200 includes four identical, and hence balanced, dipole arms 254. FIG. 3B is a graph comparing the cross-polarization isolation performance of the radiating elements of FIGS. 2A and 3A. As shown in FIG. 3B, cross-polarization isolation ranges from −22 dB to −14 dB across the 1695-2690 MHz operating frequency band for mid-band radiating element 200. In contrast, cross-polarization isolation ranges from −27 dB to −21 dB across the 1695-2690 MHz operating frequency band for mid-band radiating element 100, meaning that the worst case cross-polarization isolation is improved by about 7 dB when the unbalanced radiating element 100 is used.

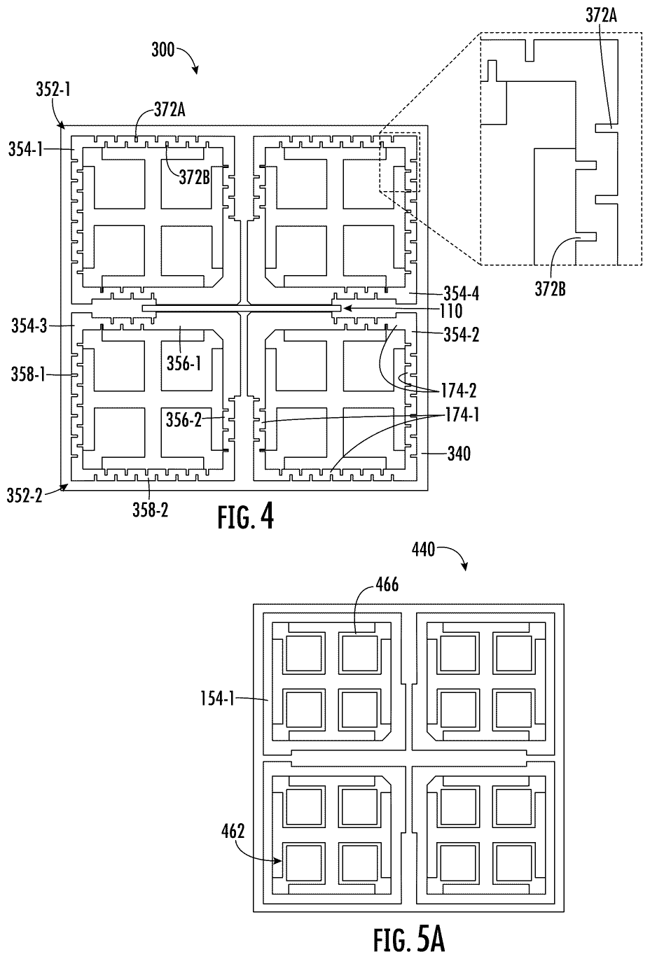

FIG. 4 is a schematic front shadow view of a mid-band cross-polarized radiating element 300 according to further embodiments of the present invention.

As can be seen by comparing FIGS. 2A and 4A, mid-band radiating element 300 may be identical to radiating element 100 except that radiating element 300 has a different design for its dipole radiators 352 and dipole arms 354. In particular, as can best be seen in the call-out in FIG. 4, the annular square metal ring that forms each dipole arm 354 has a plurality of inwardly-extending slots 372A and a plurality of outwardly-extending slots 372B where the metal is omitted. The slots 372 may, in some embodiments, extend generally perpendicular to the direction of the instantaneous current flow along the dipole arms 354 (the current flows along the four sides of the dipole arm 354, either from the center of the dipole radiator printed circuit board 340 outwardly or from the distal end of the dipole arm 354 inwardly). The inwardly-extending slots 372A and the outwardly-extending slots 372B may alternate along the length of each dipole arm 354, which forces the current to flow along an undulating path, thereby increasing the electrical length of each dipole arm 354 as compared to an identical dipole arm that did not include the slots 372A, 372B. As a result, the overall size of the dipole arms 354 may be reduced as compared to dipole arms 154 while still covering the same operating frequency band. The smaller dipole arms 354 mean that the radiating elements 300 take up less room in a base station antenna, and also may include less metal and hence interfere less with any higher-band radiating elements mounted rearwardly of the radiating elements 300.

The first inner side 156-1 and the second outer side 158-2 form a first metal arm segment 174-1 of each dipole arm 354 and the second inner side 156-2 and the first outer side 158-1 form a second metal arm segment 174-1 of each dipole arm 354. A first (base) end of the first metal arm segment 174-1 may be physically connected to a first (base) end of the second metal arm segment 174-1 and a second (distal) end of the first metal arm segment 174-1 may be physically connected to a second (distal) end of the second metal arm segment 174-2. As a result, the first and second metal arm segments of each dipole arm form a conductive loop that has an open interior. In other embodiments, the first (base) ends of the first metal arm segments 174 of each dipole arm 354 may not be physically connected to each other and/or the second (distal) ends of the first metal arm segments 174 of each dipole arm 354 may not be physically connected to each other. The same is true with respect to the other radiating elements disclosed herein.

While the slots 372A, 372B are shown as extending perpendicular to the longitudinal axis of each inner side 156 and outer side 158 of the dipole arms 354, embodiments of the present invention are not limited thereto. In other embodiments, the inwardly-extending slots 372A and/or the outwardly-extending slots 372B may extend at oblique angles with respect to the longitudinal axes of some or all of the inner sides 156 and/or outer sides 158 of the dipole arms 354. The number slots 372A, 372B and/or the spacing between slots 372A, 372B may also be varied from that which is shown, and the spacing between slots need not be constant (as shown in FIG. 4). In other embodiments the widths of inner sides 156 and/or outer sides 158 of the dipole arms 354 may be increased as can the length of the slots 372A, 372B in order to further increase the electrical length of the dipole arms 354 as compared to the physical length thereof.

Thus, as shown in FIG. 4, pursuant to further embodiments of the present invention, radiating elements 300 are provided that comprise a first dipole radiator 352-1 that comprises a first dipole arm 354-1 and a second dipole arm 354-2 and a second dipole radiator 352-2 that comprises a third dipole arm 354-3 and a fourth dipole arm 354-4. Each of the dipole arms 354 comprises first and second metal dipole arm segments 174-1, 174-2 that have a plurality of slots 372A, 372B where the metal is omitted, where the slots 372A, 372B are configured to increase a length of a respective current path along each of the first and second metal dipole arm segments 174-1, 174-2.

The bases of first and second metal dipole arm segments 174-1, 174-2 of each dipole arm 354 are physically connected to each other as are the distal ends thereof. As a result, each dipole arm 354 comprises an annular metal loop 176 that has an open interior. The slots may include outwardly-extending slots 372B that extend outwardly from inside the metal loops and inwardly-extending slots 372A that extend inwardly from outside the metal loops 176. Each of the dipole arms 354 may include at least two or three outwardly-extending slots 372B and at least two or three inwardly-extending slots 372A, where the outwardly-extending slots 372B and the inwardly-extending slots 372A are arranged in alternating fashion. Each of the metal loops 176 may generally define a respective annular square. A majority of the slots 372A, 372B in each side of each of the annular squares may extend perpendicular to a longitudinal direction of the side of the respective annular square. Outer sides of each annular square may have substantially constant widths. The slots 372A, 372B may have equal widths.

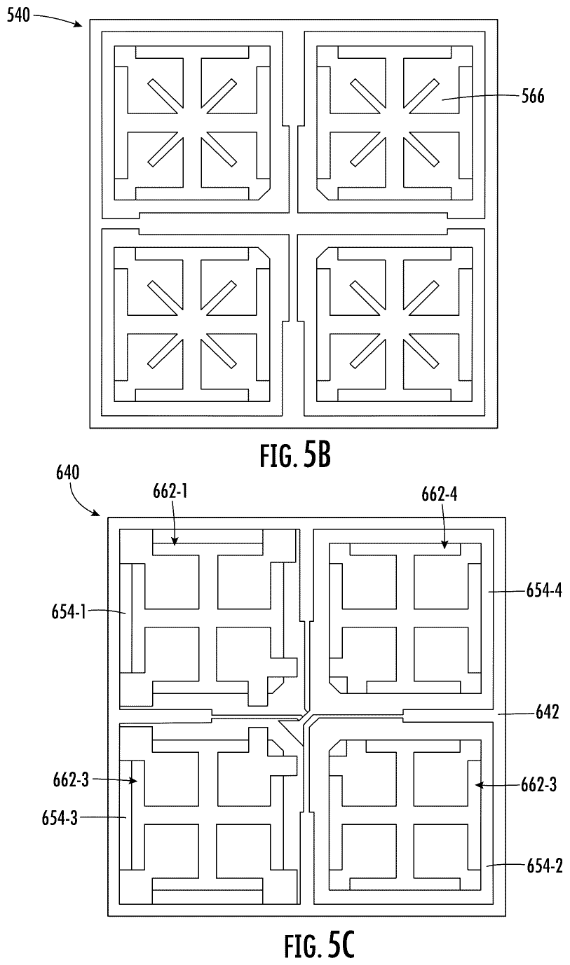

FIGS. 5A-5C are schematic front shadow views of dipole radiator printed circuit boards of mid-band radiating elements according to additional embodiments of the present invention

Referring first to FIG. 5A, a dipole radiator printed circuit board 440 is shown that is similar to dipole radiator printed circuit board 140 of mid-band radiating element 100, but has cloaking structures 462 in lieu of the cloaking structures 162. In particular, as can be seen by comparing FIGS. 2E and 4B, the only difference between dipole radiator printed circuit board 440 and dipole radiator printed circuit board 140 is that the larger metal pads 166 of dipole radiator printed circuit board 140 are solid metal pads, while the larger metal pads 466 of dipole radiator printed circuit board 440 are annular square pads having open interiors. The reduced amount of metal in pads 466 may result in less reflection of RF radiation emitted by nearby higher-band radiating elements. The omission of the metal in the middle of the larger metal pads 466 has little impact on the capacitive coupling.

FIG. 5B is a schematic front view of a dipole radiator printed circuit board 540 according to still further embodiments of the present invention. The dipole radiator printed circuit board 540 may be identical to dipole radiator printed circuit board 140 except that in dipole radiator printed circuit board 540 the larger metal pads 566 have slots 372A, 372B formed therein where the metal is omitted. As dipole radiator printed circuit board 540 otherwise is identical to dipole radiator printed circuit board 140, further description thereof will be omitted.

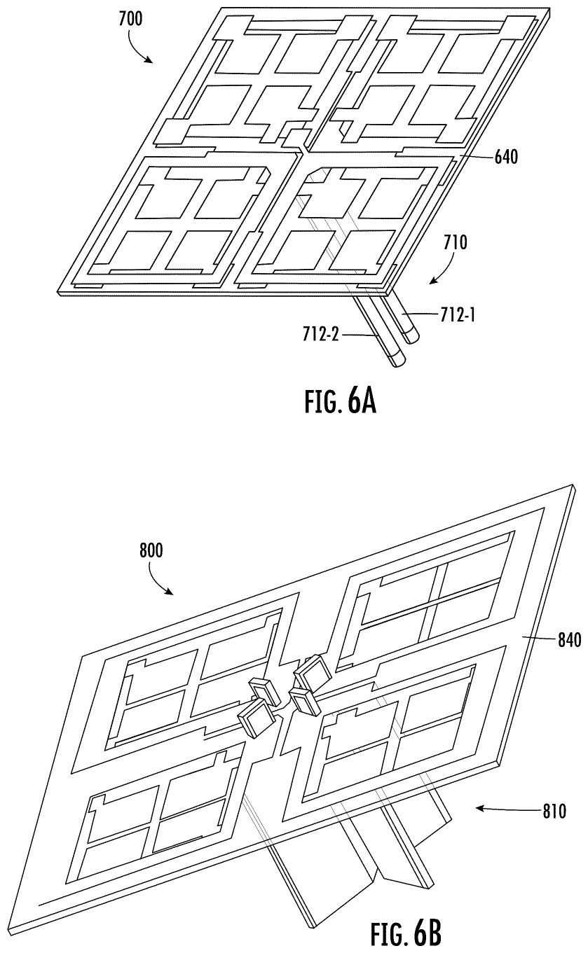

FIG. 5C is a schematic front view of a dipole radiator printed circuit board 640 according to yet additional embodiments of the present invention. The primary differences between dipole radiator printed circuit board 640 and dipole radiator printed circuit boards 140, 340, 440, 540 are that in dipole radiator printed circuit board 640 (1) some of the dipole arms 654 are implemented on a first major surface of the dielectric substrate 642 while other of the dipole arms 654 are implemented on a second major surface of the dielectric substrate 642 and (2) cloaking structures 662-1, 662-3 are implemented on the first major surface of the dielectric substrate 642 while cloaking structures 662-2, 662-4 are implemented on the second major surface of the dielectric substrate 642. Dipole radiator printed circuit board 640 is intended to illustrate shows that each dipole arm and each cloaking structure in the mid-band radiating elements according to embodiments of the present invention may be implemented on either side of their respective dipole radiator printed circuit boards. It can also be seen in FIG. 5C that the capacitors 170 that are provided in mid-band radiating element 100 between selected ones of the dipole arms 154 are omitted in dipole radiator printed circuit board 640. As discussed below with reference to FIGS. 6A-6B, according to further embodiments of the present invention mid-band radiating elements are provided that are similar to mid-band radiating element 100, but include a balanced feed stalk. When a balanced feed stalk is used, the capacitors 170-1, 170-2 will typically be omitted.

FIGS. 6A and 6B are schematic front shadow views of mid-band radiating elements according to further embodiments of the present invention. In particular, FIG. 6A illustrates a mid-band radiating element 700 that includes the dipole radiator printed circuit board 640 discussed above with reference to FIG. 5C and a feed stalk 710 that comprises a pair of coaxial feed cables 712-1, 712-2. FIG. 6B illustrates a mid-band radiating element 800 that includes a dipole radiator printed circuit board 840 that is identical to dipole radiator printed circuit board 140 except that dipole radiator printed circuit board 840 does not include the capacitors 170-1, 170-2. The capacitors 170-1, 170-2 are omitted in mid-band radiating element 800 because radiating element 800 includes a feed stalk 810 that comprises a conventional pair of feed stalk printed circuit boards in a “cross” arrangement, which provides a balanced feed to the dipole radiator printed circuit board 840. It will be appreciated that any of the above-discussed radiating elements according to embodiments of the present invention may include the two coaxial cable feed stalk of FIG. 6A or the two feed stalk printed circuit board feed stalk of FIG. 6B. If a balanced feed stalk is provided, the capacitors between the dipole arms may be omitted,

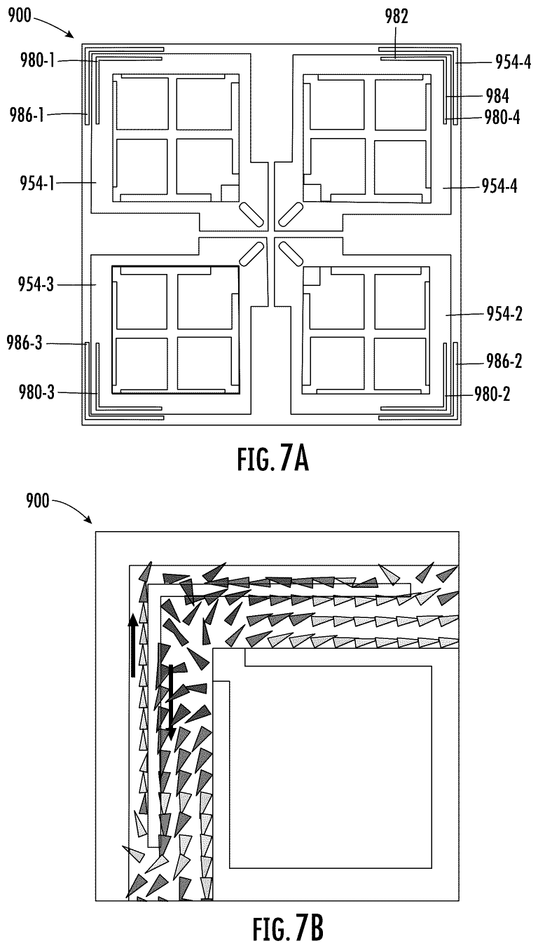

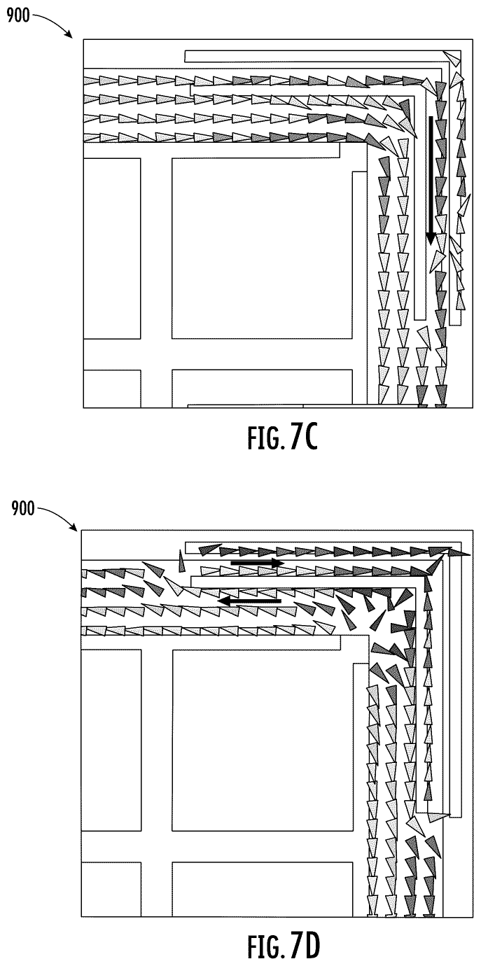

FIG. 7A is a schematic front shadow view of a mid-band radiating element 900 according to still further embodiments of the present invention. FIGS. 7B-7D are enlarged schematic front shadow views of a corner of the mid-band radiating element of FIG. 7A that illustrates the current distribution on the radiating element in response to different types of higher-band radiation. Mid-band radiating element 900 is similar to mid-band radiating element 100 of FIGS. 2A-2F so the description below will focus on the differences between the two radiating elements 100, 900.

As can be seen by comparing FIGS. 2E and 7A, mid-band radiating element 900 differs from radiating element 100 in that radiating element 900 in two ways. First, mid-band radiating element 900 includes first through fourth narrow, right-angle slots 980-1 through 980-4 that are provided in the outer corner of the respective first through fourth dipole arms 954-1 through 954-4. In the depicted embodiment, each right-angle slot 980 includes first and second straight slot segments 982, 984 where the metallization is omitted that meet to form the right-angle slot 980. Each right-angle slot 980 may have a length that is ¼ of a wavelength of a frequency within the operating frequency band of a nearby higher-band radiating element (not shown). For example, each right-angle slot 980 may have a length that is ¼ of a wavelength of a center frequency of the operating frequency band of the nearby higher-band radiating element or a frequency that is in the lower half of the operating frequency band of the nearby higher-band radiating element. Herein, the length of a slot (or trace) that does not fully extend along a single axis refers to the sum of the lengths of the individual segments of the slot (or trace). Thus, the length of each right-angle slot 980 is the sum of the lengths of the first and second straight slot segments 982, 984.

Second, mid-band radiating element 900 includes first through fourth narrow, right-angle traces 986-1 through 986-4 that are provided radially outside the outer corners of the respective first through fourth dipole arms 954-1 through 954-4. In the depicted embodiment, the first through fourth narrow, right-angle traces 986-1 through 986-4 that are provided in the same metallization layer as the first through fourth dipole arms 954-1 through 954-4 and are separated from the respective dipole arms 954 by a narrow gap so that the narrow, right-angle traces 986 are capacitively coupled to the respective dipole arms 954. Each narrow, right-angle trace 986 may have a length that is ¼ of a wavelength of a frequency within the operating frequency band of a nearby higher-band radiating element (not shown). For example, each narrow, right-angle trace 986 may have a length that is ¼ of a wavelength of a center frequency of the operating frequency band of the nearby higher-band radiating element or a frequency that is in the lower half of the operating frequency band of the nearby higher-band radiating element.

The right-angle slot 980 and the narrow, right-angle traces 986-1 through 986-4 are designed to improve the cloaking performance of mid-band radiating element 900 as compared to mid-band radiating element 100, particularly at the lower end of the operating frequency range of nearby high-band radiating elements. The right-angle slot 180 and the narrow, right-angle traces 986-1 through 986-4 are designed so that they do not negatively impact the mid-band antenna beams generated by mid-band radiating element 900.

FIG. 7B is an enlarged schematic front shadow view of a corner of one of the dipole arms 954 of the mid-band radiating element 900 that illustrates the current distribution on the dipole arm 954 in response to different types of higher-band radiation. In particular, FIG. 7B illustrates the current distribution on dipole arm 954 in response to higher-band RF radiation (emitted by a nearby radiating element that operates in the 3.4-4.0 GHz frequency band) when that the narrow, right-angle trace 986 is not present. As shown in FIG. 7B, the direction of the high-band currents on the outer side of the right-angle slot 980 is opposite the direction of the high-band currents on the inner side of the right-angle slot 980. As a result, the right angle slots 980 facilitate cancellation of the high-band currents, improving the cloaking performance of the dipole arms 954.

FIG. 7C is an enlarged schematic front shadow view of a corner of one of the dipole arms 954 of the mid-band radiating element 900 that illustrates the current distribution on the dipole arm 954 when the narrow, right-angle trace 986 is included. As shown in FIG. 7C, the direction of the high-band currents on the right-angle trace 986 is opposite the direction of the high-band currents on the dipole arm 954. As a result, the right-angle traces 986 facilitate cancellation of the high-band currents, improving the cloaking performance of the dipole arms 954.

Note that the direction of the high-band currents around the outer side of the right-angle slot 180 in FIG. 7C is not opposite the direction of the high-band currents on the inner side of the right-angle slot 980. This is because FIG. 7B illustrates the high-band current distribution on a −45° polarized mid-band dipole arm 954 in response to RF radiation emitted by a nearby −45° polarized high-band dipole radiator, while FIG. 7C illustrates the high-band current distribution on a +45° polarized mid-band dipole arm 954 in response to RF radiation emitted by a nearby −45° polarized high-band dipole radiator. FIG. 7D illustrates how the current distributions shown in FIG. 7C change if the high-band currents are formed in response to RF radiation emitted by a nearby +45° polarized high-band dipole radiator.

It will be appreciated that many modifications may be made to the radiating elements discussed above without departing from the scope of the present invention. For example, while the radiating elements according to embodiments of the present invention are described above as mid-band radiating elements that cloak in the high-band frequency range, in other embodiments the radiating element could be low-band radiating elements that is cloaked in the mid-band operating frequency range. As another example, while the dipole arms of the mid-band radiating elements described above are implemented in dipole radiator printed circuit boards, it will be appreciated that embodiments of the present invention are not limited thereto. For example, in other embodiments, the dipole arms may be implemented as sheet metal dipole arms or using other metal structures.

The radiating elements according to embodiments of the present invention may be included in multi-band base station antennas, and may reduce the amount of interaction between the arrays in the different frequency bands. Base station antennas that include the radiating elements according to embodiments of the present invention may be used, for example, as sector antennas in the above-described cellular communications systems.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Herein, the term “substantially” means within +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A radiating element, comprising:
a feed stalk printed circuit board that comprises a first radio frequency (“RF”) transmission line and a second RF transmission line;
a first dipole radiator that is coupled to the first RF transmission line, the first dipole radiator comprising a first dipole arm and a second dipole arm; and
a second dipole radiator that is coupled to the second RF transmission line, the second dipole radiator comprising a third dipole arm and a fourth dipole arm,
wherein a first amount of coupling between the first dipole arm and the third dipole arm exceeds a second amount of coupling between the first dipole arm and the fourth dipole arm.

2. The radiating element of claim 1, wherein a third amount of coupling between the second dipole arm and the fourth dipole arm exceeds a fourth amount of coupling between the second dipole arm and the third dipole arm.

3. The radiating element of claim 1, wherein the feed stalk printed circuit board is positioned between the first dipole arm and the third dipole arm and between the second dipole arm and the fourth dipole arm.

4. The radiating element of claim 2, wherein each of the first through fourth dipole arms is positioned next to two other of the first through fourth dipole arms so that the first through fourth dipole arms together define a square when viewed from the front, with each of the first through fourth dipole arms having a first inner side and a second inner side that each extend outwardly from a center of the square and a first outer side and a second outer side that each define a respective portion of a periphery of the square.

5. The radiating element of claim 4, wherein each of the first through fourth dipole arms comprises a metal loop having an open interior.

6. The radiating element of claim 5, wherein a difference between the first amount of coupling and the second amount of coupling is provided by a first capacitor that is provided between a distal end of the first inner side of the first dipole arm and a distal end of the second inner side of the third dipole arm.

7. The radiating element of claim 6, wherein a difference between the third amount of coupling and the fourth amount of coupling is provided by a second capacitor provided between a distal end of the first inner side of the second dipole arm and a distal end of the second inner side of the fourth dipole arm.

8. (canceled)

9. The radiating element of claim 1 in combination with a base station antenna, where the radiating element is one of a plurality of lower frequency band radiating elements, and an array of higher frequency band radiating elements is mounted rearwardly of the radiating element.

10. The radiating element of claim 9, further comprising first through fourth metal cloaking structures that overlap the respective first through fourth dipole arms, where the first through fourth metal cloaking structures are configured to render the respective first through fourth dipole arms substantially transparent to RF radiation emitted by the higher frequency band radiating elements.

11-13. (canceled)

14. The radiating element of claim 9, wherein each of the first through fourth dipole arms comprises a metal loop having an open interior.

15. The radiating element of claim 14, wherein the metal loop of the first dipole arm includes a slot where the metal is omitted.

16. The radiating element of claim 15, wherein the slot includes first and second slot segments that meet to define a right angle.

17. The radiating element of claim 15, wherein the slot is positioned adjacent an outer corner of the first dipole arm.

18. The radiating element of claim 15, wherein a length of the slot is a quarter wavelength of a frequency within an operating frequency band of the higher frequency band radiating elements.

19. The radiating element of claim 14, further comprising first through fourth metal traces that are positioned radially outwardly of the respective first through fourth dipole arms and configured to capacitively couple with the respective first through fourth dipole arms.

20-21. (canceled)

22. A radiating element, comprising:
a feed stalk printed circuit board that comprises a first radio frequency (“RF”) transmission line and a second RF transmission line;
a first dipole radiator that is coupled to the first RF transmission line, the first dipole radiator comprising a first dipole arm and a second dipole arm; and
a second dipole radiator that is coupled to the second RF transmission line, the second dipole radiator comprising a third dipole arm and a fourth dipole arm,
wherein the feed stalk printed circuit board is positioned between the first dipole arm and the third dipole arm and between the second dipole arm and the fourth dipole arm, and
wherein distal ends of facing inner sides of the first and third dipole arms are spaced more closely together than distal ends of facing inner sides of the first and fourth dipole arms.

23. The radiating element of claim 22, wherein distal ends of facing inner sides of the second and fourth dipole arms are spaced more closely together than distal ends of facing inner sides of the second and third dipole arms.

24. The radiating element of claim 23, wherein facing inner sides of the first and third dipole arms are symmetric about a first axis and facing inner sides of the first and fourth dipole arms are symmetric about a second axis.

25-42. (canceled)

43. A radiating element, comprising:
a first dipole radiator that comprises a first dipole arm and a second dipole arm, the first dipole radiator configured to transmit and receive electromagnetic radiation within a first operating frequency band; and
a second dipole radiator that comprises a third dipole arm and a fourth dipole arm, the second dipole radiator configured to transmit and receive electromagnetic radiation within the first operating frequency band; and
first through fourth metal cloaking structures that form resonant circuits with the respective first through fourth dipole arms, where the resonant circuits are configured to allow currents in the first operating frequency band to flow on the first through fourth dipole arms while blocking currents in a second operating frequency band from flowing on the first through fourth dipole arms,
wherein a first amount of coupling between the first dipole arm and the third dipole arm exceeds a second amount of coupling between the first dipole arm and the fourth dipole arm.

44. (canceled)

45. The radiating element of claim 43, wherein each of the first through fourth metal cloaking structures forms a multi-stage resonant circuit with a respective one of the first through fourth dipole arms.

46-73. (canceled)
